(19) United States
(12) Patent Application Publication
(10) Pub. No.: US 2006/0001646 A1
(43) Pub. Date: Jan. 5, 2006

(54) Finger worn and operated input device

(76) Inventor: Wei Hai, Santa Clara, CA (US)

Correspondence Address: FORTUNE LAW GROUP LLP, 100 CENTURY CENTER COURT, SUITE 315, SAN JOSE, CA, 95112, US

(21) Appl. No.: 10/883,886

(22) Filed: Jul. 2, 2004

(51) Int. Cl. G09G 5/00

(52) U.S. Cl. 345/156

(57) ABSTRACT

A finger worn and operated input device includes a housing having a “C” shaped cross section, a control portion disposed on the housing, and a processing circuit coupled to the control portion.

### BACKGROUND OF THE INVENTION

The present invention relates to input devices and more particularly to a finger worn and operated input device.

Conventional input devices such as the computer mouse and trackballs suffer from the disadvantage of requiring that a user strain the muscles of his arm, and more particularly, of his forearm which often leads to conditions such as repetitive strain injury, carpal tunnel syndrome, bursitis, and tendonitis. Improvements in the art have resulted in input devices having ergonomic features intended to relieve the user of these conditions.

One approach to reducing strain involves moving the input device from a desktop to the user's hand. To this end, gloves having an integral mouse are disclosed in U.S. patent application Publication 2003/0137489 and in U.S. patent application Publication 2004/0012564. A wearable ergonomic computer mouse is disclosed in U.S. patent application Publication 2003/0038783 and a hand-supported mouse for computer input is disclosed in U.S. patent application Publication 2002/0175894.

A finger mounted computer mouse is disclosed in U.S. patent application Publication 2002/0067342. The disclosed mouse includes a ball which can be rotated with the user's thumb to move a cursor to different positions on a computer screen. The position of the mouse on the user's finger is adjusted by a second finger which is adjacent the finger on which the mouse is mounted. The ball can be used to click on areas of a computer screen over which the cursor is superimposed.

An input device worn on a user's thumb is disclosed in U.S. patent application Publication 2003/0214481. The disclosed device includes a thimble shaped housing having a three dimension position sensor. By touching the position sensor with a finger, a three dimensional vector may represent the fingertip touch position and the pressure of the touch.

U.S. patent application Publication 2004/0080493 discloses an index-finger computer mouse. The mouse includes a sleeve for wearing on an index finger at a natural anatomic resting position of the thumb on the finger. Mouse manipulation is achieved by the combined action of the thumb and the index finger, which is controlled by the intrinsic musculature of the hand and is more accurate and more sensible to joint movement than the extrinsic extensor muscles of the forearm. The mouse further includes a tracking roller for controlling movements of a cursor on a screen, a first switch for performing left-key mouse functions, and a second switch for performing right-key mouse functions. A scrolling roller may provide for page-up and page-down scrolling operations.

The finger worn and operated input devices of the prior art suffer the disadvantage of not being adapted to fit different finger sizes of various users. The input device disclosed in U.S. patent application Publication 2004/0080493 includes a sleeve. The input device disclosed in U.S. patent application Publication 2003/0214481 includes a thimble. Neither input device is adjustable. Additionally, the finger worn and operated input devices of the prior art do not provide for acceleration of a cursor or other object being controlled by the input device.

As such there is a need in the art for a finger worn and operated input device that is adjustable to fit different finger sizes of various users. The input device preferably provides for acceleration of the cursor or other object being controlled by the input device.

### SUMMARY OF THE INVENTION

In accordance with the present invention, a finger worn and operated input device includes a housing having a “C” shaped cross section, a control portion disposed on the housing, and a processing circuit coupled to the control portion.

In accordance with an alternate embodiment of the present invention, a finger worn and operated input device includes a first portion having a “C” shaped cross section, a control portion disposed on the first portion, a second portion coupled to the first portion, and a processing circuit disposed in the second portion, the processing circuit coupled to the control portion.

In accordance with yet another alternative embodiment of the present invention, a fingerworn and operated input device includes a housing having a first portion of arcuate cross section coupled to a second portion of arcuate cross section, a hinge coupled between the housing first portion and the housing second portion, a control portion disposed on the first portion, and a processing circuit coupled to the control portion.

In accordance with another alternative embodiment of the present invention, a finger worn and operated input device includes a housing having a “C” shaped cross section, a first control portion disposed on the housing, a second control portion disposed on the housing, and a processing circuit coupled to the first and second control portions.

These and other features, aspects and advantages of the present invention will become better understood with reference to the following drawings, description and claims.

### BRIEF DESCRIPTION OF THE DRAWINGS

FIG. 1 is a perspective view of a finger worn and operated input device in accordance with the present invention;

FIG. 2 is a perspective view of the finger worn and operated input device showing a “C” shaped cross section in accordance with the present invention;

FIG. 3 is a perspective view of a first portion of the finger worn and operated input device in accordance with the present invention;

FIG. 4 is a top view of a control portion of the finger worn and operated input device in accordance with the present invention;

FIG. 5 is a side elevation view of the control portion of the finger worn and operated input device in accordance with the present invention;

FIG. 6 is a schematic representation of a processing circuit in accordance with the invention;

FIG. 7 is a perspective view of a first alternative embodiment of the finger worn and operated input device in accordance with the present invention;

FIG. 8 is a perspective view of a second alternative embodiment of the finger worn and operated input device in accordance with the present invention;

FIG. 9 is a flow chart of a motion detection method in accordance with the present invention; and

FIG. 9 is a flow chart of a motion command method in accordance with the present invention.

### DETAILED DESCRIPTION OF THE INVENTION

The following detailed description is of the best currently contemplated modes of carrying out the present invention. The description is not to be taken in a limiting sense, but is made merely for the purpose of illustrating the general principles of the invention, since the scope of the invention is best defined by the appended claims.

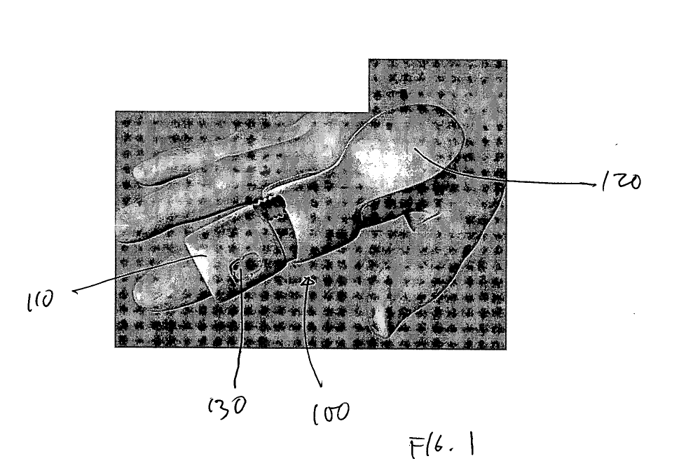

A finger worn and operated input device generally designated 100 is shown in FIG. 1. Finger worn and operated input device 100 may include a first portion 110 and a second portion 120, second portion 120 electrically and mechanically coupled to first portion 110. First portion 110 may be worn on a user's index finger at a intermediate phalangeal section of the index finger. In this position, finger worn and operated input device 100 may be advantageously operated by the user's thumb. While the finger worn and operated input device 100 is shown disposed on the user's index finger at the mid-phalangeal section of the index finger, it will be clear from the description herein that the finger worn and operated input device 100 may be worn on any user finger and in any convenient position upon such finger.

Second portion 120 may be worn on a same user finger as first portion 110 at a proximate phalangeal section of the user's finger. Second portion 120 may include a processing circuit as described herein. In alternative embodiments of the invention, finger worn and operated input device 100 may include only first portion 110 in which case the processing circuit may be disposed in first portion 110.

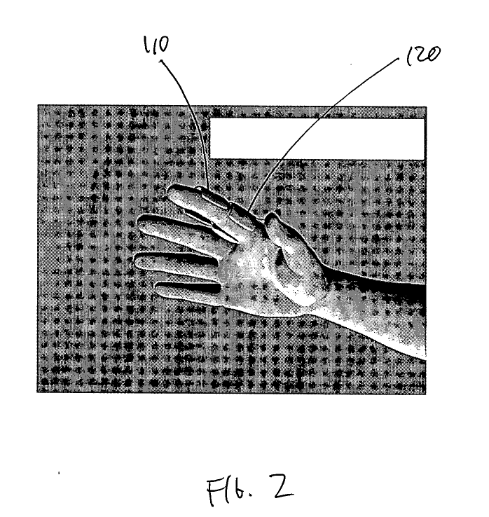

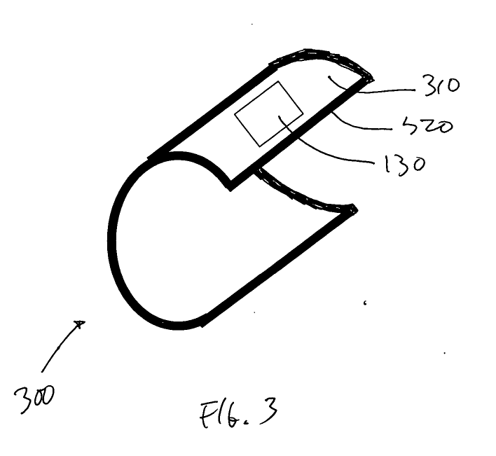

With reference to FIG. 2, finger worn and operated input device 100 may have a “C” shaped cross section as shown in FIG. 2 and FIG. 3. Preferably finger worn and operated input device 100 may be formed of a flexible material such as plastic and silicone. In this manner finger worn and operated input device 100 may be adapted to fit various sizes of user fingers.

First portion 110 may include a control portion 130. Control portion 130 may be disposed proximate a first portion edge 320 as shown in FIG. 3 such that the user can access control portion 130 with his thumb while the finger worn and operated input device 100 is mounted on the user's finger.

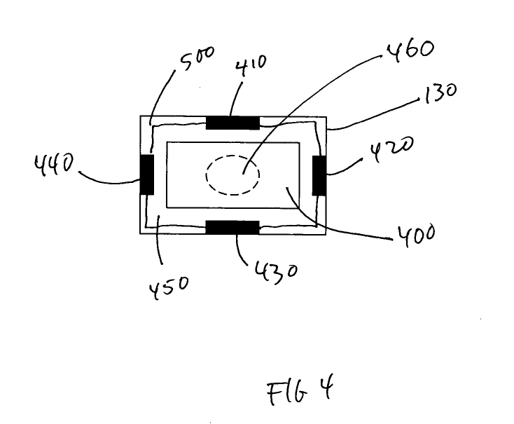

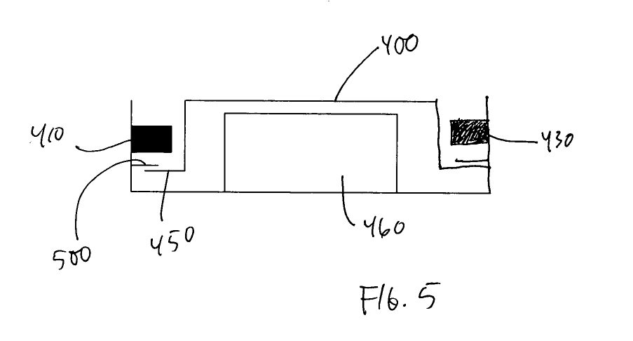

With reference to FIG. 4 and FIG. 5, control portion 130 may include sensing devices 410, 420, 430, and 440 disposed orthogonally one from the other. Sensing devices 410, 420, 430, and 440 may include single layer thin film on/off switches, double layer thin film on/off switches, variable resistance switches, variable capacitance switches, and optical light sensors. Double layer thin film on/off switches may include two single layer thin film on/off switches stacked one upon the other.

A pad 400 may be moveably disposed in control portion 130 for contact engagement with sensing devices 410, 420, 430, and 440. Pad 400 may be formed from an elastic material such as plastic and silicone. Pad 400 may include lateral tabs 450 for retaining pad 400 within stops 500. Movement of pad 400 by the user's thumb making contact with sensing devices 410, 420, 430, and 440 may be operable to provide sensing devices 410, 420, 430, and 440 with a signal indicating a direction. Thus by way of example, contact of pad 400 with sensing device 410 may indicate an upward direction, contact of pad 400 with sensing device 420 may indicate a rightward direction, contact of pad 400 with sensing device 430 may indicate a downward direction, and contact of pad 400 with sensing device 440 may indicate a leftward direction. Additionally, contact of pad 400 with sensing devices 410 and 420 may indicate an upward/rightward direction, contact of pad 400 with sensing devices 420 and 430 may indicate a rightward/downward direction, contact of pad 400 with sensing devices 430 and 440 may indicate a leftward/downward direction, and contact of pad 400 with sensing devices 440 and 410 may indicate an upward/leftward direction. Other directions may be achieved as described herein.

A selection button 460 may be disposed under pad 400 and be operable to provide a selection function. Depression of selection button 460 by the user's thumb may provide the selection function. Depression of selection button 460 in combination with contact of pad 400 with sensing devices 410, 420, 430, and 440 may be operable to provide a “click and drag” function.

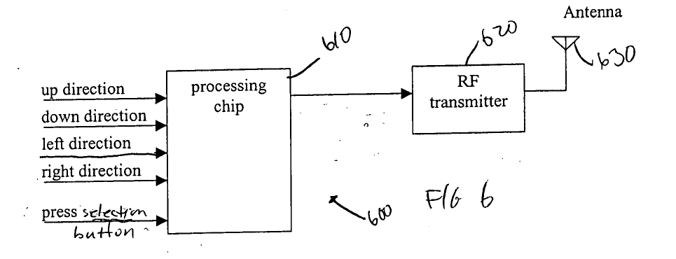

A processing circuit generally designated 600 is shown in FIG. 6. Processing circuit 600 may be disposed in second portion 120. Processing circuit 600 may include a processing chip 610 operable to encode data for transmission by an RF transmitter 620 coupled to processing chip 610 and antenna 630. A receiver (not shown) may receive signals from the finger worn and operated input device 100 for control of the cursor or other object being controlled.

Processing chip 610 may receive input signals from control portion 130 in response to the user's thumb movements which may move pad 400 into contact with sensing devices 410, 420, 430, and 440 and selection button 460. Input signals may include an upward direction signal, a rightward direction signal, a downward signal, a leftward signal, a selection signal, and combinations of these signals. Processing chip 610 may be operable to encode these signals to provide encoded data to the RF transmitter 620.

Processing chip 610 may be operable to encode data representative of acceleration of a cursor or other object being controlled. Processing chip may receive as input a signal from sensing devices 410, 420, 430, and 440 indicating the persistent contact of pad 400 with sensing devices 410, 420, 430, and 440. Processing chip 610 may be programmed to encode such persistent contact as acceleration of the cursor or other object being controlled. In an aspect of the invention sensing devices 410, 420, 430, and 440 may include double layer thin film on/off switches. Turning on a first layer switch by contact of pad 400 may represent a constant velocity while turning on a second layer switch may represent acceleration of the cursor or other object being controlled. Movement of the cursor or other object being controlled in a plurality of directions may be accomplished by accelerating the cursor or other object being controlled in a first direction and then simultaneously contacting pad 400 with a sensing device representative of a second direction thereby effecting movement in a third direction.

In another aspect of the invention, a finger worn and operated input device generally designated 300 is shown in FIG. 3. A housing 310 may include control portion 130. Processing circuit 610 may be disposed inside housing 310.

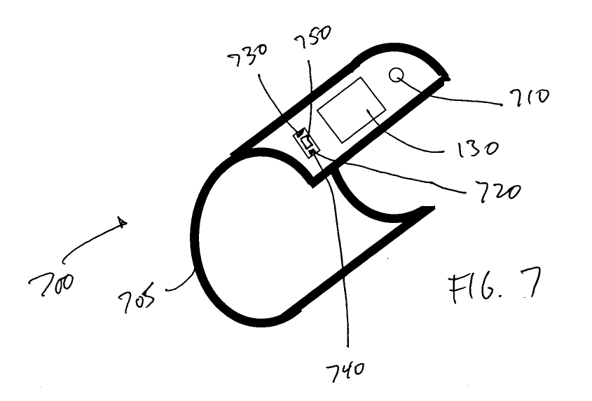

In yet another aspect of the invention, a finger worn and operated input device generally designated 700 is shown in FIG. 7. A housing 710 may include control portion 130, a right click selection button 710, and a second control portion 720 having two sensing devices 730, 740 and a pad 750 for providing an up/down scrolling function.

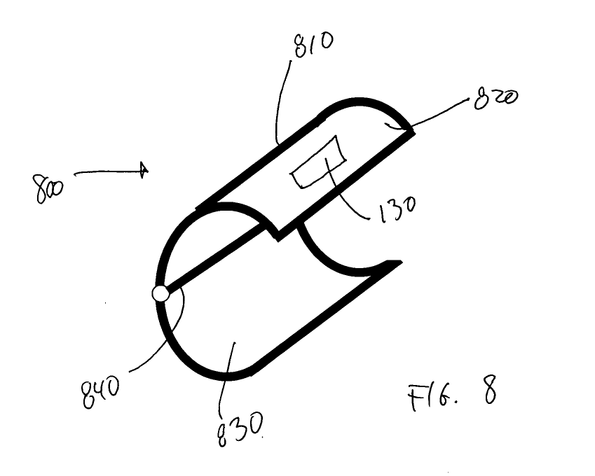

With reference to FIG. 8, a finger worn and operated input device generally designated 800 is shown including a housing 810 having a first housing portion 820 having disposed thereon control portion 130 and a second housing portion 830 attached to first housing portion by means of hinge 840. Processing circuit 600 may be disposed inside housing 810. Hinge 840 may be of conventional design and provide for step wise movement of first housing portion 820 relative to second housing portion 830. In this manner, finger worn and operated input device 800 may be adjustable to fit various user's finger sizes and shapes.

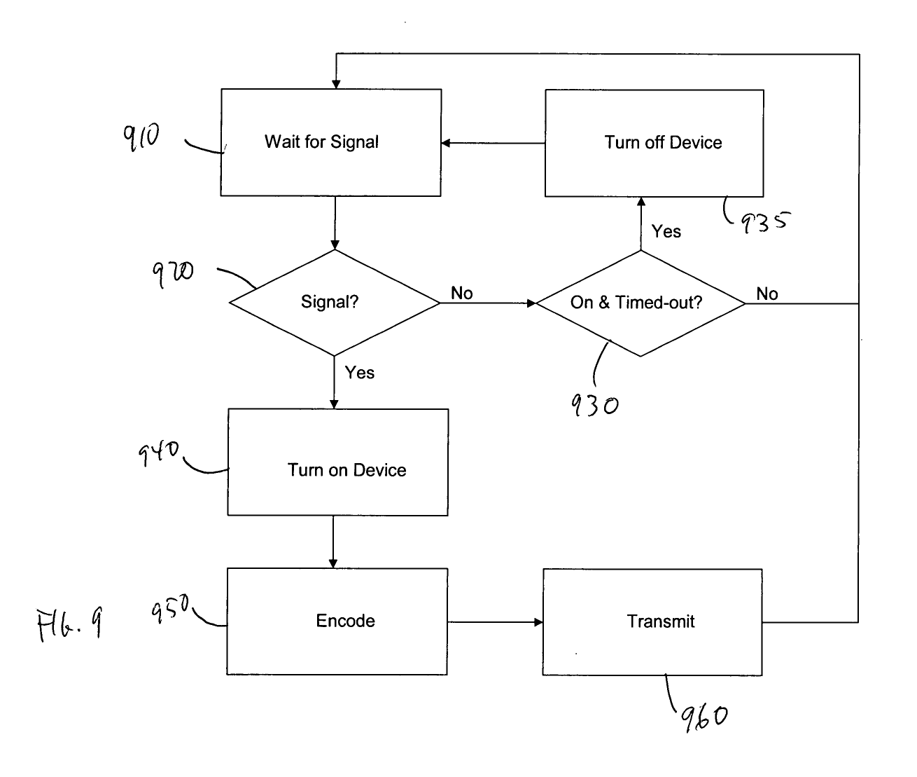

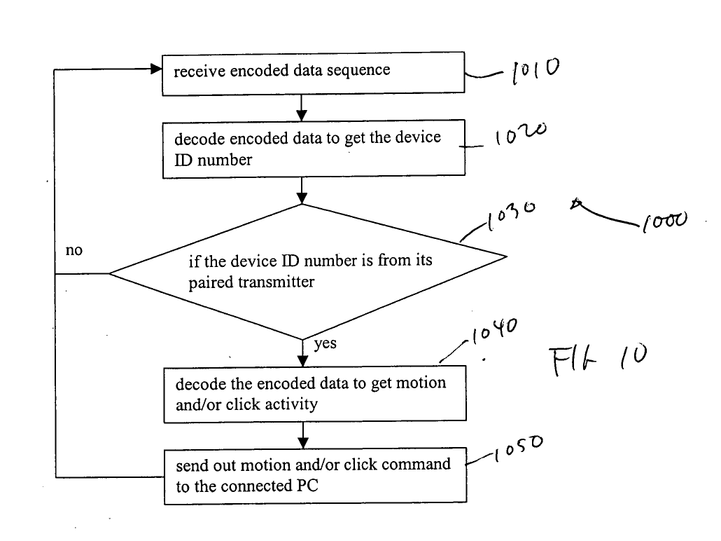

A motion detection method generally designated 900 is shown in FIG. 9. In a step 910 processing circuit 600 may wait for a signal from control portion 130. Signals may include contact with sensing devices 410, 420, 430, 440, 730, and 740 or selection of selection button 460. In a step 920 it is determined if a signal has been received. If no signal has been received then in a step 930 it is determined if the finger worn and operated input device 100 is on and a predetermined time has elapsed since a last signal has been received. If the finger worn and operated input device 100 is either not on or a predetermined time has not elapsed, then the method 900 returns to step 910 else the finger worn and operated input device 100 is turned off in a step 935.

If a signal is received in step 920, then the finger worn and operated input device 100 is turned on in a step 940. In a step 950 the processing circuit 600 may encode the signal and in a step 960 the encoded data may be transmitted. The encoded data may include a finger worn and operated input device 100 identification. The method 900 then returns to step 910 to wait for another signal.

A motion command method generally designated 1000 is shown in FIG. 10. In a step 1010 the encoded data may be received by a receiver coupled to a PC or other device having a cursor or other object being controlled by the finger worn and operated input device 100. The encoded data may be decoded in a step 1020. In a step 1030 it may be determined if the finger worn and operated input device 100 identification matches a receiver identification. If there is no match the method 1000 returns to step 1010. If there is a match, then in a step 1040 the encoded data is further decoded to determine the movement of the pad 400 by the user and the selection of selection button 460 by the user. In a step 1050 the user's movement and selections are translated into cursor movements or movements of other objects being controlled.

The finger worn and operated input device 100 of the present invention provides an input device adapted to fit various finger sizes and shapes. Furthermore, the input device provides a means for accelerating the cursor or other object being controlled. The input device advantageously does not have any protruding features thereby enabling use of the finger worn and operated input device 100 without fear of injury. The input device further provides clicking and dragging functionality.

It should be understood, of course, that the foregoing relates to preferred embodiments of the invention and that modifications may be made without departing from the spirit and scope of the invention as set forth in the following claims. More particularly, the finger worn and operated input device 100 may be used in connection with any device requiring user input such as game devices, audio equipment, and video equipment in addition to conventional personal computers having cursors.

We claim:

1. A finger worn and operated input device comprising:
a housing having a “C” shaped cross section;
a control portion disposed on the housing; and
a processing circuit coupled to the control portion.

2. The finger worn and operated input device of claim 1, wherein the control portion comprises a moveable pad.

3. The finger worn and operated input device of claim 2, wherein the control portion comprises a selection button disposed under the moveable pad.

4. The finger worn and operated input device of claim 2, wherein the control portion comprises a plurality of sensing devices.

5. The finger worn and operated input device of claim 4, wherein the moveable pad is moveable to contact the sensing devices to provide signals to the processing circuit.

6. The finger worn and operated input device of claim 1, wherein the sensing devices include single layer thin film switches.

7. The finger worn and operated input device of claim 1, wherein the sensing devices include two single layer thin film switches stacked one upon the other.

8. A finger worn and operated input device comprising:
a first portion having a “C” shaped cross section;
a control portion disposed on the first portion;
a second portion coupled to the first portion; and
a processing circuit disposed in the second portion, the processing circuit coupled to the control portion.

9. The finger worn and operated input device of claim 8, wherein the control portion comprises a moveable pad.

10. The finger worn and operated input device of claim 9, wherein the control portion comprises a selection button disposed under the moveable pad.

11. The finger worn and operated input device of claim 9, wherein the control portion comprises a plurality of sensing devices.

12. The finger worn and operated input device of claim 11, wherein the moveable pad is moveable to contact the sensing devices to provide signals to the processing circuit.

13. A finger worn and operated input device comprising:
a housing having a first portion of arcuate cross section coupled to a second portion of arcuate cross section;
a hinge coupled between the housing first portion and the housing second portion;
a control portion disposed on the first portion; and
a processing circuit coupled to the control portion.

14. The finger worn and operated input device of claim 13, wherein the control portion comprises a moveable pad.

15. The finger worn and operated input device of claim 14, wherein the control portion comprises a selection button disposed under the moveable pad.

16. The finger worn and operated input device of claim 14, wherein the control portion comprises a plurality of sensing devices.

17. The finger worn and operated input device of claim 16, wherein the moveable pad is moveable to contact the sensing devices to provide signals to the processing circuit.

18. A finger worn and operated input device comprising:
a housing having a “C” shaped cross section;
a first control portion disposed on the housing;
a second control portion disposed on the housing; and
a processing circuit coupled to the first and second control portions.

19. The finger worn and operated input device of claim 18, wherein the first control portion comprises a first moveable pad and the second control portion comprises a second moveable pad.

20. The finger worn and operated input device of claim 19, wherein the first control portion comprises a first selection button disposed under the first moveable pad and the second control portion comprises a second selection button disposed under the second moveable pad.

21. The finger worn and operated input device of claim 19, wherein the first control portion comprises a plurality of first portion sensing devices and the second control portion comprises a plurality of second portion sensing devices.

22. The finger worn and operated input device of claim 21, wherein the first moveable pad is moveable to contact the first portion sensing devices to provide first portion signals to the processing circuit and the second moveable pad is moveable to contact the second portion sensing devices to provide second portion signals to the processing circuit.

23. The finger worn and operated input device of claim 18, further comprising a selection button disposed on the housing and coupled to the processing circuit.
